(19) United States
(12) Patent Application Publication
(10) Pub. No.: US 2021/0283515 A1
(43) Pub. Date: Sep. 16, 2021

(54) Gaming docking station for mobile phone

(71) Applicant: Andres Del Valle, Newington, CT (US)

(72) Inventor: Andres Del Valle, Newington, CT (US)

(21) Appl. No.: 16/820,050

(22) Filed: Mar. 16, 2020

(51) Int. Cl. A63F 13/98; A63F 13/92; A63F 13/235; H04M 1/215

(52) U.S. Cl. CPC A63F 13/98; H04M 1/215; A63F 13/235; A63F 13/92

(57) ABSTRACT

The present invention concerns a gaming docket for a mobile phone. The device is collapsible and can connect wirelessly to the mobile phone. The device is configured to adapt to any smartphone regardless of size. The wireless configuration allows the device to be used with android or Iphone or any future operating system.

### BACKGROUND OF THE INVENTION

### 1. Field of the Invention

This invention relates invention relates to a controller for releasably capturing a mobile phone and controlling gaming software on the mobile phone.

### 2. Description of the Prior Art

Gaming software has been available for decades and can be loaded onto a computer or a mobile device so that controls associated with the device are used to play the game. Movement of the controller alters the activities that appear on the device screen and affect the outcome of the game. The controller typically is a joystick, a steering wheel or some form of mouse that can be manipulated easily by the game player to make rapid or subtle movements that affect the way the game is being played out.

Dedicated computerized games also have been available for decades. Some electronic games are connectable to a television, while other electronic games have their own screens. Electronic games also have their own controllers that are configured to control the performance of the game in an optimal manner. Thus, an electronic game is likely to have a joystick, steering wheel, a pad with directional arrows or some version of a mouse.

Cellular phone usage continues to expand rapidly and competition is intense among the manufacturers of cellular phones and the providers of cellular phone services. This competition has driven manufacturers to meet consumer demands for smaller, lighter phones packed with more features. The common features for all types of mobile phones are a keypad, keys or buttons for entering command or control functions (e.g., send, clear, end, etc.) for entering alphanumeric data, a small screen and accessible terminals for recharging the battery of the phone.

Most cellular phone manufacturers incorporate gaming software into the phone in an effort to cater to the many consumers who have grown up with electronic games. The software enables the consumer to use the keypad and control buttons of the phone to control video images on the screen of the phone for playing a particular game permitted by the memory and hardware of the phone. The 2, 4, 6 and 8 keys on the phone are generally used to move the cursor on the screen (2=up, 4=left, 6=right 8=down). Some phones and some games permit more subtle movements with the 1, 3, 7 and 9 keys. Other keys (e.g., *, 0, #, 5, clear, etc.) are used for other controls (e.g., shoot, brake, jump) through a menu of possible games. Most cellular phones accommodate several games with a level of complexity and sophistication that was unavailable on general purpose computers several years ago. However, cellular phone game controls are nowhere near as ergonomic and user friendly as the controls available on a typical video game or on a general purpose computer. In particular, the fast-paced video game is not played easily by pressing keys that control the directional movement of a cursor. Furthermore, the very small smartphone keypad further complicates efforts to input instructions to the cellular phone for quickly and precisely controlling the actions to be taken by a cursor on a small screen.

In view of the above, it is an object of the subject invention to provide a game controller that will permit more ergonomic use of gaming software incorporated into a cellular phone.

It is another object of the subject invention to provide a docking station and game controller that can be used with any of a plurality of different types of cellular phones.

### SUMMARY OF THE INVENTION

The present invention concerns a gaming docket for a mobile phone. The device is collapsible and can connect wirelessly to the mobile phone. The device is configured to adapt to any smartphone regardless of size. The wireless configuration allows the device to be used with android or Iphone® or any future operating system.

It is a major object of the invention to provide an improved mobile phone gaming docket.

It is another object of the invention to provide an improved mobile phone gaming docket that is collapsible.

It is another object of the invention to provide an improved mobile phone gaming docket that connects wirelessly to a mobile phone.

### BRIEF DESCRIPTION OF THE DRAWINGS

FIG. 1 shows a plan view of the device connected to a mobile phone.

FIG. 2 shows a plan view of a component of the device.

FIG. 3 show a side view of the component of FIG. 2 in a collapsed mode.

FIG. 4 shows a side view of another component used with the device.

FIG. 5 shows a side view of the device connected to a mobile phone.

### DETAILED DESCRIPTION OF THE PREFERRED EMBODIMENTS

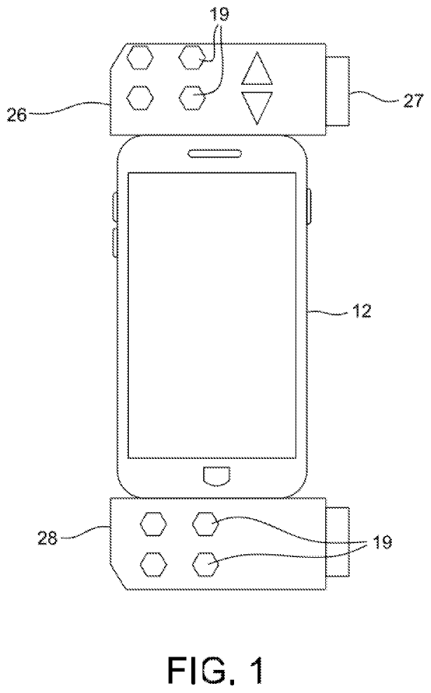

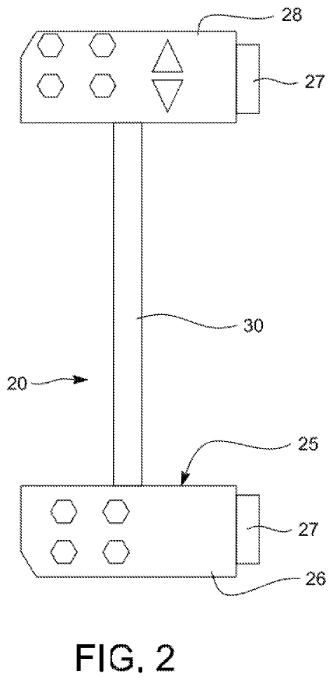

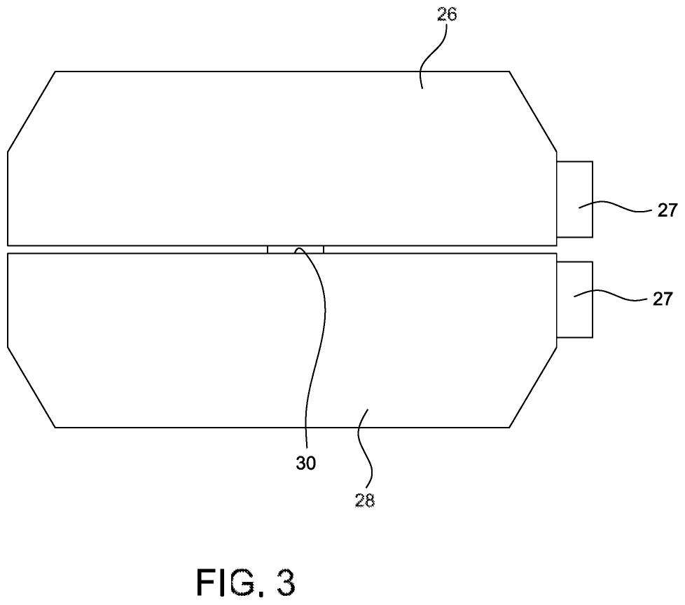

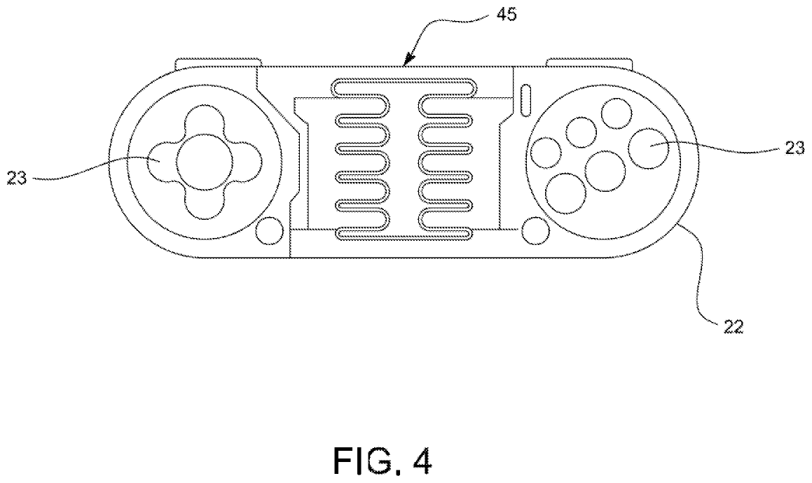

Referring now to FIGS. 1-5, the device 10, and a typical smartphone 12 are shown. The term smartphone as used herein is intended to describe any small hand held computing device which may be used for communication purposes. Accordingly, the term “smartphone” is meant to include cell phones, mobile phones, PDAs, or any other future hand held communication device. It should be noted that because of screen requirements, virtually all smartphones are flat, elongated and rectangular and thus will have opposing edge regions 14, 16 to which the inventive device 10 can attach. Also, the device 10 is intended for use with any mobile computing device which has a display and is suitably sized for use with the inventive device. It can be seen that the device 10 has two components 20, 22 which cooperate to partially enclose the smartphone 12. The first component 20 is essentially a collapsible clamp having opposing end portions 26, 28 connected by a two part telescoping connecting member 30. Thus, end portions 26, 28 can be spaced apart as far as telescoping member 30 allows. Telescoping member 30 can be as long as needed to accommodate any smartphone device, and may have a rectangular, oval, or circular cross section. Component 20 can be electrically connected to component 22 which is a standard game controller device. Thus it can be seen that component 20 provides an ergonomically efficient grasping member for the hands of the user while component 22 provides the standard digital control signals via the various pushbutton switches 23. Component 20 includes thumb switches 27, as well as additional redundant switches or buttons 19, which redundant switches correspond to switches on component 22. Switches 27 are preferably used as thumb triggers as is known in the art, as they are easily operable by thumb. Component 20 can be collapsed for storage and transport as can be seen in FIG. 3. The interior surfaces 25 of end portions 26, 28 are shaped for frictional fit with the edge of the smartphone 12 to allow the smartphone to “nestled” therein while assembling the device 10, this to prevent slipping of the smartphone 12. Alternatively or additionally, telescoping member 30 may be spring loaded (biased in the closed position as shown in FIG. 3) or include other means to set the spacing between end portions 26, 28 as would be apparent to one of skill in the art.

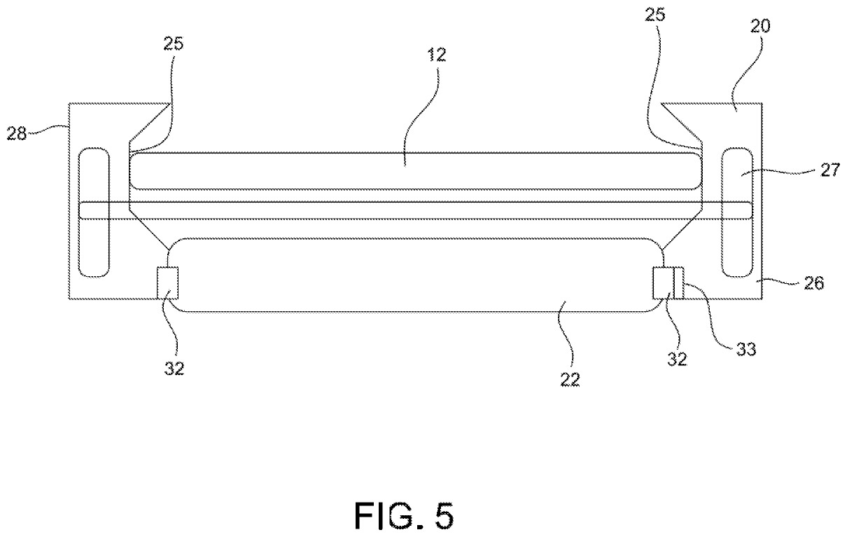

When completely assembled as shown in FIG. 5 it can be seen that component 20 surrounds the edge regions of the smartphone 12 while component 22 covers the rear.

Interlocking tabs 32 serve to connect the two components 20, 22, with at least one of the tabs 32 having an electrical contact which mates with electrical contact in corresponding recess 33 to effect electrical connection between components 20, 22. Of course, both components 20, 22 will have suitable digital circuitry to perform the various tasks as described herein as would be apparent to one of skill in the art.

In a preferred embodiment, device 10 will communicate to the mobile phone 12 wirelessly using, e.g., bluetooth, using transmission protocols to effect an interface between the phone 12 and the device 10 as would be apparent to one of skill in the art. It can be appreciated that physical electrical connection between the phone 12 and the device 10 would be difficult because of the varying and ever changing connector arrangement among the different brands and models of mobile phones. Using the wireless connection, however configured, would allow the phone 12 to accept control signals from the device 10, which control signals would correspond to activation of the switches and buttons on the device 10.

Component 22 includes switches 23 to perform various game operations and is more or less standard. A key aspect of the invention is that it provides both an ergonomic grasping surface, as well as a means to connect a standard game controller to any phone without regard to the physical arrangement of the mobile phone input port/connector (e.g., shape or pin arrangement).

In operation, to connect the device 10, the user simply expands component 20 of the device 10 from the collapsed state as discussed above and shown in FIG. 3 to the expanded position as shown in FIG. 1 and temporarily secures the smartphone 12 therein as by friction as described above. The user then connects the two components 20, 22 via tabs 32, recess 33 forming a physical and electrical connection between the two. The bluetooth connection is then initiated in the well known manner. Power for the device 10 comes from battery 45 contained in component 22. The user then switches on the device 10 to begin game play.

It is to be understood that the present invention is not limited to the sole embodiment described above, but encompasses any and all embodiments within the scope of the following claims:

I claim:

1. A device for connecting a mobile phone to an external video game controller comprising:
a first component having opposing end portions connected by a telescoping connecting member;
a second component having game control buttons, said second component physically and electrically attachable to said first component;
whereby said first component provides a grasping surface with trigger switches.

2. The device of claim 1 wherein said first component includes buttons having functional equivalence to said game control buttons.

3. The device of claim 1 wherein said first component includes a recessed space to temporarily hold said mobile phone.

4. The device of claim 1 wherein each of said end portions has a thumb trigger.

5. The device of claim 1 wherein said telescoping member is spring biased to enclose said mobile phone.

6. The device of claim 1 wherein said device is connected wirelessly to said phone via bluetooth.
